(19) United States
(12) Patent Application Publication
(10) Pub. No.: US 2002/0057212 A1
(43) Pub. Date: May 16, 2002

(54) MULTIMODAL MULTIMEDIA TRANSPORTATION INFORMATION SYSTEM

(76) Inventors: LULA RENEE HAMILTON, FEDERAL WAY, WA (US); LAWRENCE MICHAEL MOORE, FEDERAL WAY, WA (US)

Correspondence Address: LAW OFFICES OF JAN CAROL LITTLE, P O BOX 566, SEATTLE, WA, 981180566

(21) Appl. No.: 09/295,202

(22) Filed: Apr. 20, 1999

(51) Int. Cl. G08G 1/123

(52) U.S. Cl. 340/988; 340/989

(57) ABSTRACT

A multimodal multimedia transportation information system uses a processor, software, computer signals, and display units to integrate several transportation modes. The system tracks, monitors, collects, extracts, analyzes, processes, forecasts, stores, distributes, and presents transportation information to and from the various transportation modes. The display units are located on buses, ferries, trains, subways, emergency vehicles, airports, etc., and in airports and other buildings where passengers may want real-time transportation information. The system presents real-time data on display units located within a transportation network. This data include scheduling, road conditions, weather, emergency information from state and local governments, routing, closures, status, locations, arrival and departure times, advertisements of products and services, messages, fares, connection times, traffic information, etc.

### TECHNICAL FIELD

The invention is related generally to intelligent transportation systems, and in particular, to a multimodal multimedia transportation information system.

### BACKGROUND OF THE INVENTION

Transit systems usually maintain the status of their buses by tracking their location and condition, collecting the associated data, and transmitting the data to operations centers, etc. by global positioning satellite (GPS) or transponder systems. Ferry systems, airlines, rail systems, etc., also track and collect data. However, many of these conventional modes of transportation are limited.

For example, one transportation mode is generally not interconnected with other transportation modes. Many current transit systems use obsolete tracking systems, which employ hardware that is inadequate and thus costly to interconnect with other systems. Moreover, any software cannot be easily interfaced with obsolete hardware.

Similarly, current transportation systems rarely offer transportation information to customers of one transportation mode about another transportation mode. Bus riders, for instance, have no way of knowing whether a particular ferry, subway, etc., is late or rerouted. At best, bus system customers have to rely on paper bus and ferry schedules, or call in to a rider information line to get departure and arrival times. This is especially cumbersome to passengers using a combination of buses, trains, subways, ferries, etc., because they must obtain and safeguard the schedule and route changes for each transportation mode. Moreover, most existing transportation modes do not distribute real-time data directly to passengers or at workplaces with transit dependent employees.

It can be appreciated therefore that what is needed is a centralized system that integrates information from various transportation modes and provides the integrated information in real-time to commuters. The invention provides this and other advantages as will be illustrated by the following description and accompanying drawings.

### SUMMARY OF THE INVENTION

Presented herein are systems and corresponding methods to track collect, extract, analyze, process, forecast, store, distribute, and present transportation information to and from various, often dissimilar, transportation modes. An exemplar transportation network presents real-time data on multimedia displays located on individual transportation units, at passenger stops, and buildings. This data include scheduling, road conditions, weather, emergency information from state and local governments, routing, closures, status, locations, arrival and departure times, advertisements of products and services, messages, fares, connection times, traffic information, etc.

One system includes a processor, software, signals, and display units or devices interconnected to extract the data from the various transportation modes, process the data, and present it on the display units associated with the various transportation modes in an attractive, passenger-friendly manner. The display units are located on buses, ferries, trains, subways, emergency vehicles, etc., and in airports and other buildings where passengers may want real-time transportation information.

Further features and advantages of the invention as well as the structure and operation of various embodiments are described in detail below.

### BRIEF DESCRIPTION OF THE FIGURES

The invention is best understood by reference to the figures wherein references with like reference numbers indicate identical or functionally equivalent elements. In addition, the left-most digits refer to the figure in which the reference first appears in the accompanying figures.

FIG. 1 illustrates a transportation network suitable for use with an exemplar multimodal multimedia transportation information system.

FIG. 2 is a block diagram of an example embodiment of a multimodal control center interfaced with a transit system and a ferry system.

FIG. 3 is flowchart of a routine performed by an exemplar multimodal control center to collect, extract, process, and present transportation information on a display unit.

FIG. 4 is a geographical representation of implementation of an exemplar multimodal multimedia information system.

FIGS. 5-22 each illustrates a display unit exemplar presenting transportation information in text, graphics, and audio form.

### DETAILED DESCRIPTION OF THE INVENTION

A transportation network with a multiple mode (multimodal) multimedia transportation information system is described herein. In the following description, numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

One feature of the system is that it allows information to be shared among the various transportation modes. At a high level, the system tracks, collects, extracts, analyzes, processes, forecasts, stores, distributes, and presents transportation information to several transportation modes. It coordinates communications among the several transportation systems.

Another feature of the system is that it allows information from any or all transportation modes to be shared with people interested in transportation information. The system presents transportation information on individual transportation units. Multimedia presentations of transportation information are available from display units placed at several locations. For example, display units are located onboard buses, trains, trolleys, ferries, emergency vehicles, shuttles, inside airport terminals, ferry terminals and landings, and at train (subway, monorail, etc.) stations. They are also located at bus and trolley stops, in private and public buildings, concourses, departure and arrival gates, baggage claim, elevators, convention centers and arenas, workplaces having transit dependent employees, shopping malls, fire stations, meeting halls, houses of worship, multiple unit dwellings, hospitals, parking lots, for example.

Another feature of the system is that it enables travelers, shoppers, tourists, commuters, etc. to make informed decisions when planning their day. The system thereby facilitates efficient use of public and private transportation, which is particularly important given the current emphasis on intelligent transportation systems and commuter trip reduction.

The advertising implementation of the system has advantages, as well. It can entertain and inform. It can also provide much appreciated revenue to municipalities operating the system.

I. Example Environment

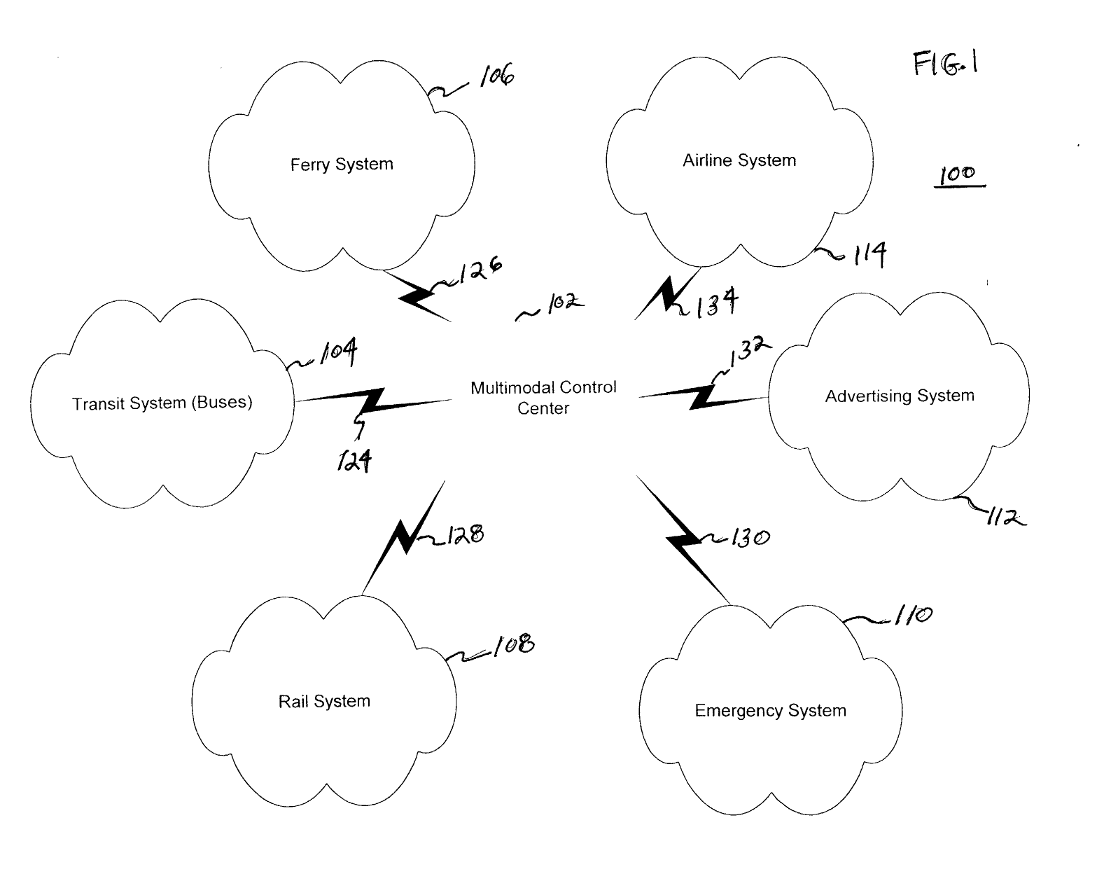

FIG. 1 is a high-level block diagram of a transportation network 100 suitable for implementing an embodiment of the invention. Portions of the transportation network 100 may be a defined space such as an outdoor area or one or more rooms in a building, such as business parks and amusement parks. The transportation network 100 may include non-specific areas, such as different nodes in a computerized communication network or sites/pages on the Internet or in “cyberspace,” such as merchant home pages and advertiser servers. The transportation network 100 also may be as large as a multi-state geographic region, such as airline and train systems.

The transportation network 100 has systems that track, monitor, collect, extract, analyze, process, forecast, store, distribute, and present “transportation information.” As used herein, the term “transportation information” is defined to include scheduling, road conditions, weather, emergency information from state and local governments, routing, closures, status, locations, arrival and departure times, advertisements of products and services, messages, fares, connection times, traffic information, etc. The term “transportation information” may also be referred to as “data,” “data content,” “passenger information,” or other terminology that can be interpreted to mean information usable by passengers of common carriers. A specific type of data is not important for the invention, and those skilled in the art will understand that a wide variety of data may be tracked, collected, extracted, analyzed, distributed, presented, etc. Moreover, the data can be in any language, such as English, Spanish, Japanese, Swedish, Chinese, Swahili, Portuguese, Afrikaans, etc.

According to an exemplar, the transportation network 100 includes at least one multimodal control center 102 that performs many of the functions described herein. That is, the multimodal control center 102 controls tracking, collection, extraction, analysis, processing, forecasting, storage, distribution, and presentation of transportation information. FIG. 1 shows an exemplar multimodal control center 102 in communication with several modes of transportation. Various transportation modes include transit systems, taxis, private shuttles, limousine, ferry systems, rail systems (e.g., elevated trains, monorails, subways, ground level trains, etc.), emergency systems (e.g., fire, medical, radiological response, etc.), trolley systems, airports, etc. A particular mode of transportation is not important for the invention, and those skilled in the art will understand that a wide variety may be used.

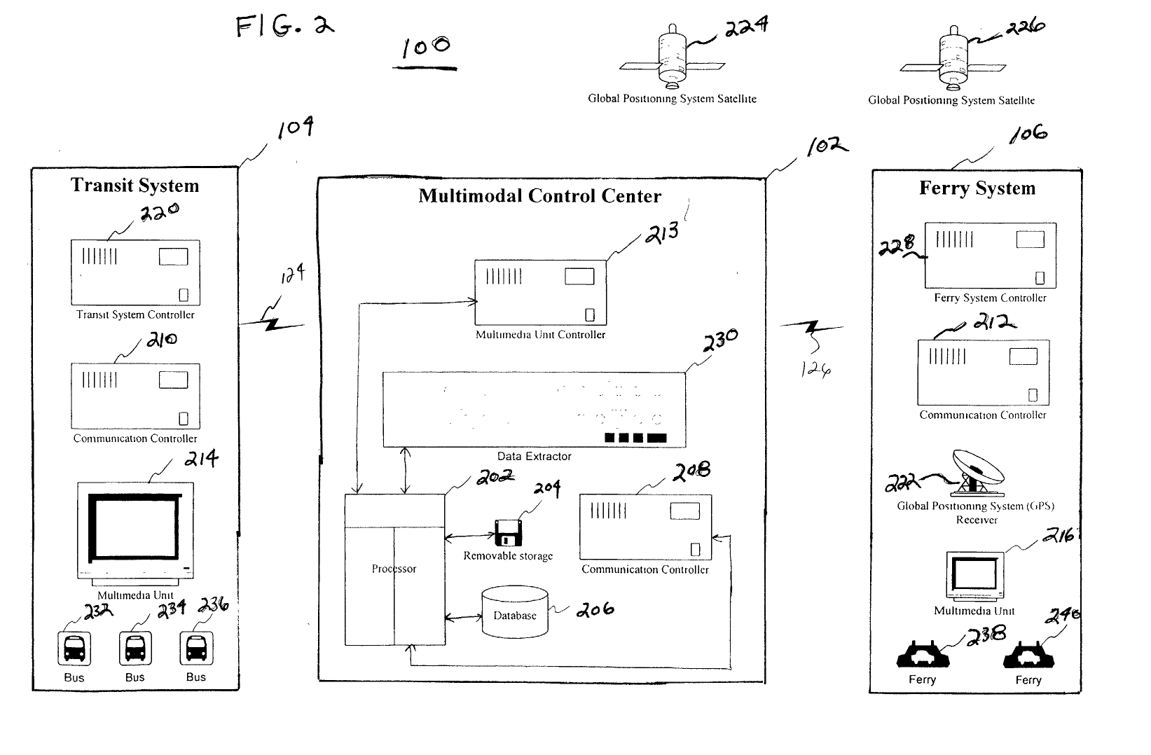

According to the exemplar, the multimodal control center 102 communicates with a transit system 104 that operates buses, trolleys, etc. For ease of explanation the various embodiments generally are described with respect to only one transit system 104. Those skilled in the art will appreciate, however, that the invention accommodates more than one transit system. For instance, in one implementation the multimodal control center 102 interfaces with transit systems in several counties in Western Washington State, including King County (Metro, Waterfront Trolley), Pierce County, and Snohomish County. The transit system 104 is described in more detail below with reference to FIG. 2.

The multimodal control center 102 also communicates with a ferry system 106, which operates passenger-only ferries and car ferries. Various embodiments generally are described with respect to only one ferry system 106. Of course the invention applies to more than one ferry system. For instance, in one implementation the multimodal control center 102 interfaces with ferry systems in several states and provinces, including Washington State Ferries, Alaska Marine Highway System, Victoria Ferry, Ltd., Victoria Clipper, etc. The ferry system 106 is described in greater detail below with reference to FIG. 2.

The multimodal control center 102 also interfaces with a rail system 108, which operates trains, subways, monorails, etc. Although the specification describes several embodiments with respect to only one rail system 108, it will be apparent to those skilled in the art will that the invention can interface with more than one rail system. Rail system implementations are similar to transit system implementations.

The multimodal control center 102 also interfaces with an emergency system 110, which provides services for fire emergencies, medical emergencies, natural disasters, radiological and industrial emergencies, etc. The emergency system 110 is described in below with reference to FIG. 2.

The multimodal control center 102 also interfaces with an advertising system 112. As used herein, “advertising” includes general non-public commercial advertising geared to selling products and services to consumers. “Advertising” also includes public service announcements, such as dates and times for town meetings, daily calendars for public officials, etc. The advertising system 112 provides advertising to the transit system 104, ferry system 106, rail system 108, emergency system 110, and an airline system 114 (described below). The advertising system 112 is described more with reference to FIG. 2.

The multimodal control center 102 also interfaces with the airline system 114, which includes several airline companies. The airline system 114 provides airline services, such as arrival and departure times, airplane status, etc.

As FIG. 1 illustrates, the multimodal control center 102 interfaces with modes of transportation via communication links 124, 126, 128, 130, 132, and 134. Example communication links include hardwired links and wireless links. Typical links include a satellite link, a radio-frequency link, an optical link, a laser link, an infra-red link, a fiber optic link, telephony, etc., or combinations thereof.

FIG. 2 shows the transportation network 100 in more detail. According to FIG. 2 the multimodal control center 102 includes a processor 202 to supervise the processes implemented to track, collect, extract, analyze, process, forecast, store, distribute and present transportation information. The processor 202 in an exemplar uses an IBM compatible computer with Windows operating system available from Microsoft Corporation. Other exemplars implement a multiple virtual storage (MVS) computer platform available from International Business Machines (IBM), or equivalent platform available from Amdahl and Hitachi Data Systems. In other embodiments, the processor 202 uses a UNIX platform, a disk operating system (DOS) platform, or a personal computer disk operating system (PC-DOS) platform. Those skilled in the art will appreciate that a variety of computer platforms may be used to implement the invention. Although only one processor 202 is shown in FIG. 2, the multimodal control center 102 can include more than one processor.

The processor 202 is connected to peripherals, which typically includes a main memory (not shown), preferably random access memory (RAM), and can also include a secondary memory, such as a hard disk/hard disk drive and/or a removable storage medium/device 204. The removable storage medium/device 204 can be a CD-ROM/floppy disk and CD-ROM/floppy disk drive combination, a magnetic tape and magnetic tape drive combination, an optical disk and optical disk drive combination, etc. The removable storage device reads from and/or writes to a removable storage medium in a well-known manner. As will be appreciated, the removable storage medium and device 204 includes a computer usable storage medium having stored therein computer software and/or data. Any well-known removable storage medium/device is suitable for implementing the removable storage medium/device 204.

The processor 202 is connected to a database 206, which in an exemplar stores data prior to distribution from the multimodal control center 102. In one embodiment, the database 206 stores advertisements, such as general non-public commercial advertising geared to selling products and services to consumers. Recall that “advertising” also includes public service announcements, such as dates and times for town meetings, daily calendars for public officials, etc. In another embodiment, the database 206 stores tracking information or other transportation information typically associated with transportation modes, such as schedules, routing information, etc. Although the database 206 is depicted as a single database, according to the embodiment of FIG. 2, the database 206 may be several databases. Any well-known database is suitable for implementing the database 206. The multimodal control center 102 also includes a communication controller 208 that allows software and data to be transferred between the multimodal control center 102 and the transportation modes. For example, the communication controller 208 for the multimodal control center 102 communicates with the transit system 104 using a communication controller 210 and with the ferry system 106 using a communication controller 212. Example devices suitable for implementing the communication controllers 208, 210, and 212 include any well-known fiber optic transceiver, modem, network interface (such as an Ethernet card), a communication port, a PCMCIA slot and card, etc. or other device that utilizes radio-frequency, optical, telephony, etc., technologies or combinations thereof

Software and data transferred via the communication controller 208 are in the form of computer data signals that can be electronic, electromagnetic, optical or other computer data signals capable of being transmitted and received by the communication controller 208. The computer data signals are provided to the communication controller 208 via a channel (not shown) that carries the computer data signal and can be implemented using wire or cable, fiber optics, a phone line, a cellular phone link, an RF link and other communications channels. Typically, the computer data signals are transmitted to and from the communication controller 208 on a “carrier” whose frequency is determined by the particular implementation. Implementation of computer data signals on carriers is well known.

The data content of the carrier also varies with the particular implementation. According to an embodiment, the data content for computer data signals transferred via the communication controller 208 include transportation information, as well as other computer instructions, code, etc., needed to operate the transportation network.

The multimodal control center 102 also includes a display unit controller 213, a display unit 214 and a display unit 216. The display unit controller 213 controls the presentation of transportation information on display units located within the transportation network 100. The display 214 and 216 present graphics, photographic images, animation, video, clips, portraits, stylized text, simple line drawings, geometric shapes, color fields, text sentences, phrases, words, etc. Each graphic may appear and disappear on the display units via a variety of different animation effects. The display units also replay digital audio (e.g., music, sound effects, etc.) and amplify human voices, as controlled by the display unit controller 213. FIG. 2 shows the transit system 104 and the ferry systems 106 with display units 214 and 216, respectively.

Any of the display units can present transportation information via digital advanced television (ATV) or other suitable high definition (HDTV) display unit or add-on component. Display units and display unit controllers suitable for implementing this embodiment of the display unit controller 212 and the display units 214 and 216 are available from Data-Display in Ronkonkoma, N.Y.

Alternatively, any of the display units can present transportation information via “reader board” technology, which is cheaper than HDTV presentation. “Reader boards,” also termed “display boards,” or “wall displays,” are electronic displays, similar to giant televisions, that are typically connected to a computer. The computer monitors the reader boards as they display information. The reader boards may be connected so that several operators can control their display.

The display units are placed strategically to ensure maximum exposure of information to transportation system users, including transit dependent employees, travelers, shoppers, tourists, consumers, etc. The display units are large enough and are positioned so they are easily enjoyed by anyone wanting to view or hear transportation information.

For example, display units can be placed onboard buses, trains, trolleys, ferries, emergency vehicles, shuttles, etc. Display units also can be placed inside airport terminals, ferry terminals and landings, train (subway, monorail, etc.) stations, at bus and trolley stops. They also can be placed in private and public buildings, concourses, departure and arrival gates, baggage claim, elevators, convention centers and arenas, workplaces having transit dependent employees, shopping malls, fire stations, meeting halls, houses of worship, multiple unit dwellings, hospitals, parking lots, etc.

Recall that the multimodal control center 102 interfaces with various transportation modes to control tracking, collection, extraction, analysis, processing, forecasting, storage, distribution, and presentation of transportation information. As for tracking, each transportation mode usually has techniques to communicate data between individual transportation units and that transportation mode's operations center. For example, transit systems typically use transponders to track buses along their routes and to monitor arrival and departure times. Some transit systems place transponders on poles (similar to telephone poles) and buses send and receive transportation information, such as location/position information and messages, in the form of a data stream, using the transponders between individual buses and a transit system controller 220. The transit system controller 220 is also used to implement other types of communications between the transit system operations center and individual buses. The information may be continually broadcast to all buses, directional to only one bus, multicast to a few select buses, etc. Implementation of transit system operations centers, including transponders, transit system controllers, and tracking systems in general, are well known.

Ferry systems typically use global positioning system (GPS) equipment to track ferries. That is, each ferry has a GPS receiver that communicates with GPS satellites orbiting the earth. The satellites transmit their positioning information, which the ferry GPS receivers use to calculate the ferry's position. The ferry system 106 includes a global positioning system (GPS) receiver 222, and the transportation network 100 includes at least two global positioning system satellites 224 and 226 to implement ferry tracking. Of course GPS satellites can communicate with GPS receivers via any suitable well-known communication link, and typically via optical links. Moreover, any medium capable of establishing and maintaining data communication between satellites and global positioning systems is acceptable.

The calculated position of each ferry is sent, in the form of a data stream, between individual ferries and a ferry system controller 228. The ferry system controller 228 is used to implement this and other types of communications between the ferry system operations center and individual ferries. The information may be continually broadcast to all ferries, directional to only one ferry, multicast to a few select ferries, etc. Implementation of ferry system operations centers, including ferry system controllers and ferry tracking systems in general, are well known. Ferry status also can be gleaned from Department of Transportation transmissions.

Other communication techniques can be utilized with these and other transportation modes as well, and the communication technique is not critical to the invention. For instance, communication of location/position information and messages can be communicated to the respective operations centers via wireless, radio-frequency communication, pager, modem, telephony, optical, laser, infra-red, etc., or combinations thereof. The transportation modes send and receive data in data streams containing all sorts of data required by the transportation mode operations centers.

The multimodal control center 102 can interface with various transportation modes to control tracking or to retrieve the data from the tracking systems. That is, unlike conventional intelligent transportation systems an exemplar of the invention integrates information from a variety of transportation modes. The exemplar monitors the data streams from the various transportation systems typically present in a geographical region and extracts (or captures) “exceptional data” from each of the data streams. The term “exceptional data” refers to, among other things, data associated with the late arrival of a transportation unit at a destination. The term “exceptional data” thus encompasses data associated with road closures, weather, traffic conditions, etc. The invention then processes the data, distributes it to the various transportation modes and presents it to display units of interest in a passenger-friendly manner.

The multimodal control center 102 includes a data extractor 230 that monitors and extracts (captures, retrieves, etc.) data from the transit system 104, the ferry system 106, the rail system 108, the emergency system 110, the advertising system 112, and the airline system 114. Because the various transportation modes usually use differing computer platforms, the data extractor 230 is designed to interface with each of them. For example, if the ferry system computer platform has an IBM compatible processor with Windows operating system the data extractor 230 interfaces to it. If the rail system 108 has an MVS processor, the data extractor 230 interfaces to it as well. If the advertising system 112 uses a UNIX platform, the airline system 114 has a disk operating system (DOS) platform, or the emergency system 110 has a personal computer disk operating system (PC-DOS) platform, the data extractor 230 interfaces to all of them. Implementation of the data extractor 230 can also be part of the particular computer platform operations. Data extraction techniques are well known.

Note that the transit system 104 includes several transportation units, as represented by buses 232, 234, and 236. Similarly, the ferry system 106 has several transportation units, as represented by ferries 238 and 240. The rail system 108 also has several trains, (not shown) the emergency system 110 has several engine companies, emergency response units, station houses, etc. (not shown), the advertising system 112 has several advertisers (not shown), and the airline system 114 has several airports and airplanes (not shown).

II. Operation of an Example Embodiment

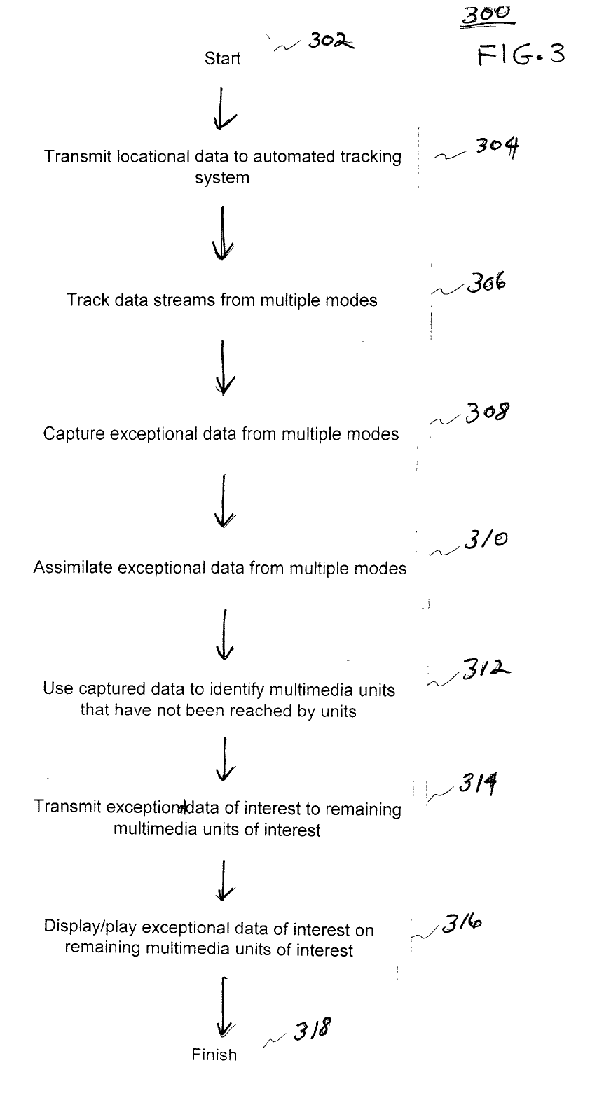

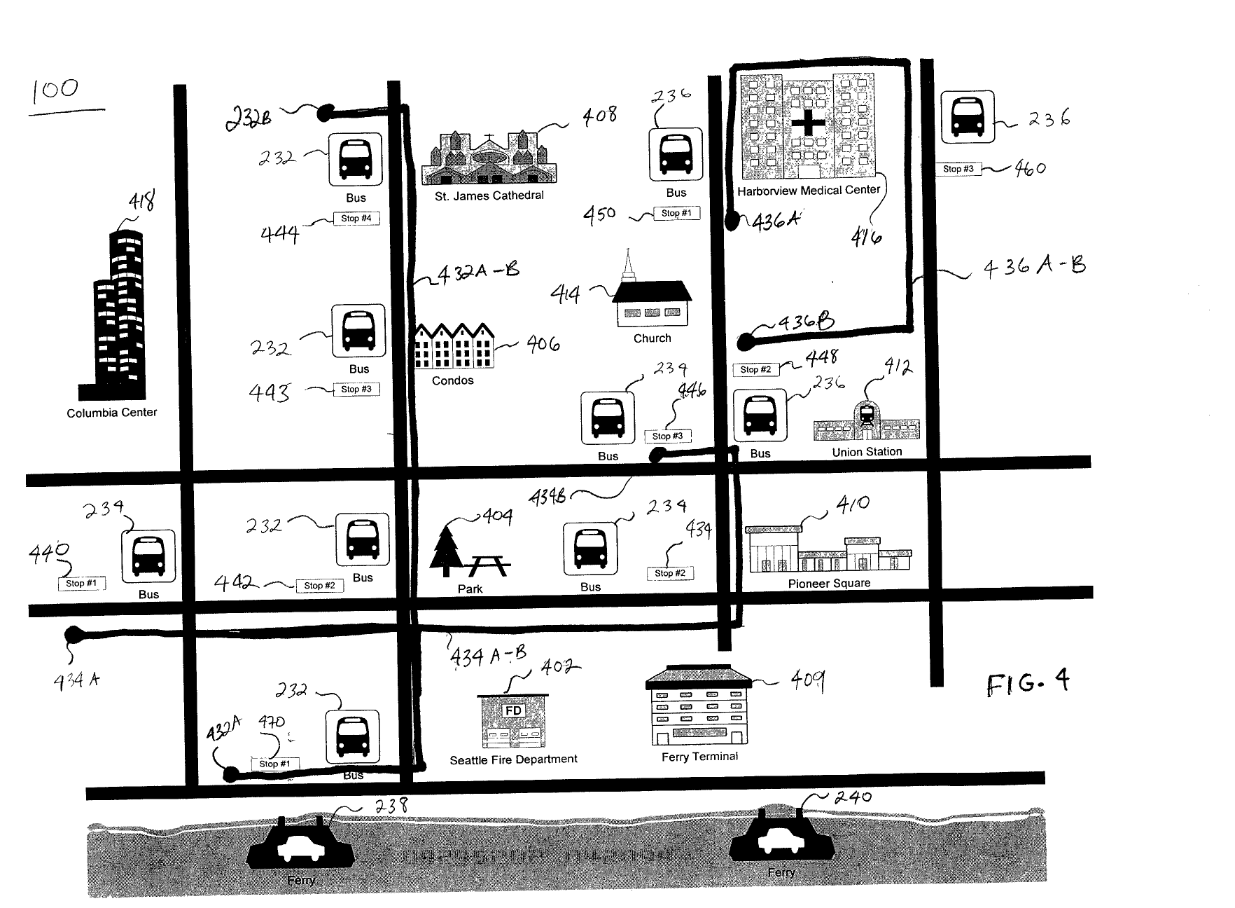

FIG. 3 is an exemplar routine 300 that the multimodal control center 102 executes to monitor, capture, process, and distribute transportation exceptional data. FIG. 4 is a more detailed depiction of the transportation network 100. The operation of an example embodiment is described with reference to FIGS. 2, 3 and 4.

FIG. 4 shows the that the bus 232 travels along route 432A-B beginning at the location 432A, passes near Seattle Fire Department 402, park 404, condos 406, St. James Cathedral 408, and ending at the location 432B. The bus 234 travels along route 434A-B beginning at the location 434A, passes near the Seattle Fire Department 402, the park 404, Ferry Terminal 409, Pioneer Square 410, Union Station 412, church 414, and ending at the location 434B. The bus 236 travels along route 436A-B beginning at the location 436A, travels around Harborview Medical Center 416, pass the church 414, Union Station 412, ending at the location 436B. Columbia Center 418 can be accessed using the bus 232 or the bus 234.

The Seattle Fire Department 402 generally houses several response vehicles (e.g., fire engines) and personnel, as is well known. During emergencies the Seattle Fire Department 402 responds to prevent and fight fires, control flooding, administer first aid, etc. According to one embodiment, the Seattle Fire Department 402 has at least one display unit to display transportation information. The park 404, the condos 406, St. James Cathedral 408, the Ferry Terminal 409, Pioneer Square 410, Union Station 412, the church 414, Harborview Medical Center 416, and Columbia Center 418 each also have at least one display unit that presents transportation information. As such, a transit passenger can view or hear transportation information at any of these locations. The display units may also be located where non-passengers can view or hear transportation information and advise potential passengers accordingly, via public address system, for example.

For purposes of illustration, suppose that a passenger at the bus 234 stop #1 440 wants to visit the St. James Cathedral 408. The bus 234 does not stop near St. James Cathedral 408, but both the bus 232 and the bus 236 come close, so the passenger has a choice of routes. Along one route the passenger can ride from the bus 234 stop #1 440, transfer to the bus 232 at the bus 232 stop #2 442, which stops at the bus 232 stop #2 442, ride pass bus 232 stop #3 443, and on to bus 232 stop #4 444. Along the other route the passenger can ride from the bus 234 stop #1 440 to the bus 234 stop #3 446, transfer to the bus 236 at the bus 236 stop #2 448, and ride to the bus 236 stop #1 450. If there is a delay along the route 434A-B because of a large gathering in the park 408 blocking the route 434A-B, for example, it would be better for the passenger to know this ahead of time so that she is not late in getting to St. James Cathedral 408.

According to the exemplar, the display units affected by the blockage present transportation information. The invention forecasts the delay to the downstream affected display units. This includes any display units located in the park 404 itself, the condos 406, St. James Cathedral 408, the Ferry Terminal 409, Pioneer Square 410, Union Station 412, the church 414, and Harborview Medical Center 416, as well as any display units located aboard ferries 238 and 240.

Task 302 begins the routine 300. Task 304 transmits positional data to an automated tracking system of interest. According to an embodiment of the invention, the bus 234 transmits its location to the transit system controller 220 at each stop. The ferry 240 transmits its position at the Ferry Terminal 409. The transit system controller 220 transmits the fact that the gathering in the park 408 is blocking the route 434A-B.

Task 306 monitors the data streams from various transportation modes. For example, the data extractor 230 monitors the data streams that the bus 234, the transit system controller 220, and the ferry 238 transmit.

Task 308 captures exceptional data from the various transportation modes. According to the example, the data extractor 230 extracts the data indicating that there is a delay along the route 434A-B because of a large gathering in the park 408 blocking the route 434A-B. The data extractor 230 also extracts the data indicating that the ferry 240 is at the ferry terminal.

Task 310 assimilates the exceptional data captured with other data from the various transportation modes. The processor 202 assimilates the following data: data indicating that the ferry 240 is at the ferry terminal; and the data indicating there is a delay along the route 434A-B. The processor 202 looks in the database 206 to check the scheduled time for the bus 234 to arrive at the bus 234 stop #1 440. The processor 202 determines that the bus 234 is on time. The processor 202 also determines that the passenger at the bus 234 stop #1 440 may want to know of this exceptional condition so she may transfer to the bus 232 at the bus 232 stop #2 442 rather to the bus 234 stop #2 434.

Task 312 analyzes the assimilated data and uses it to identify the display units of interest that have not been reached by the transportation units of interest. According to the example, the processor 202 identifies the display units located onboard the buses 234 and 232. The processor 202 identifies the display units at the bus 234 stops #1, 2, and 3, 440, 434, and 446, respectively. The processor 202 identifies the display units located at St. James Cathedral 402, in the park 408, at the ferry terminal 412, the fire department 414, at the Columbia Center 416, as well.

Task 314 transmits exceptional data of interest to the remaining display units of interest. According to the example, the multimodal control center 102 sends the data indicating that the ferry 240 is at the ferry terminal. The multimodal control center 102 also sends to the identified display units the data indicating that there is a delay along the route 434A-B.

Task 316 presents and/or plays representations of the exceptional data of interest at the display units of interest. The transit dependent employees in the Columbia Center 416, the condos 406, passengers on the bus 232 and 234, ferry 240 passengers, and drivers of cars from the ferry 240 are thereby alerted to take an alternate route, if desired. Task 318 completes the routine 300.

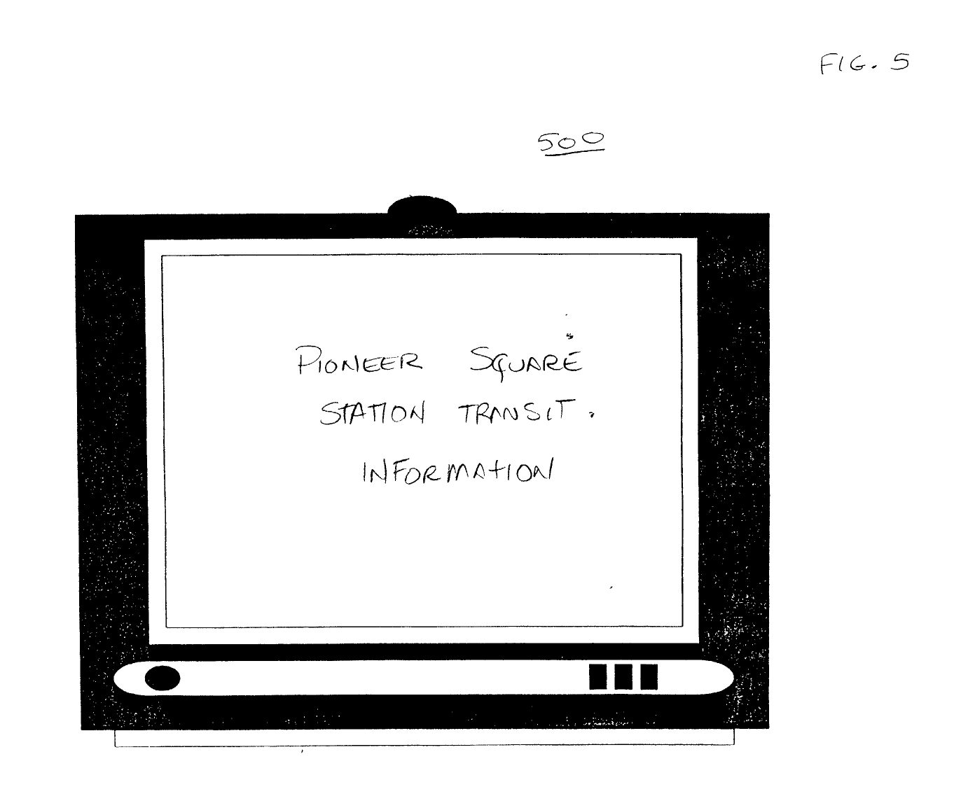

FIG. 5-22 each shows a display unit presentation of transportation information. For visually impaired passengers the all presentations of transportation information may be played either as an amplified live human voice or a digitized prerecorded human voice. Passengers can push a pre-located button. Alternatively, the display unit can automatically play transportation information simultaneously with presentations for sighted passengers.

FIG. 5 shows a display unit 500 exemplar announcing that it will display “PIONEER SQUARE STATION TRANSIT INFORMATION.” The display unit 500 thus will presents transportation information for the transit system 104.

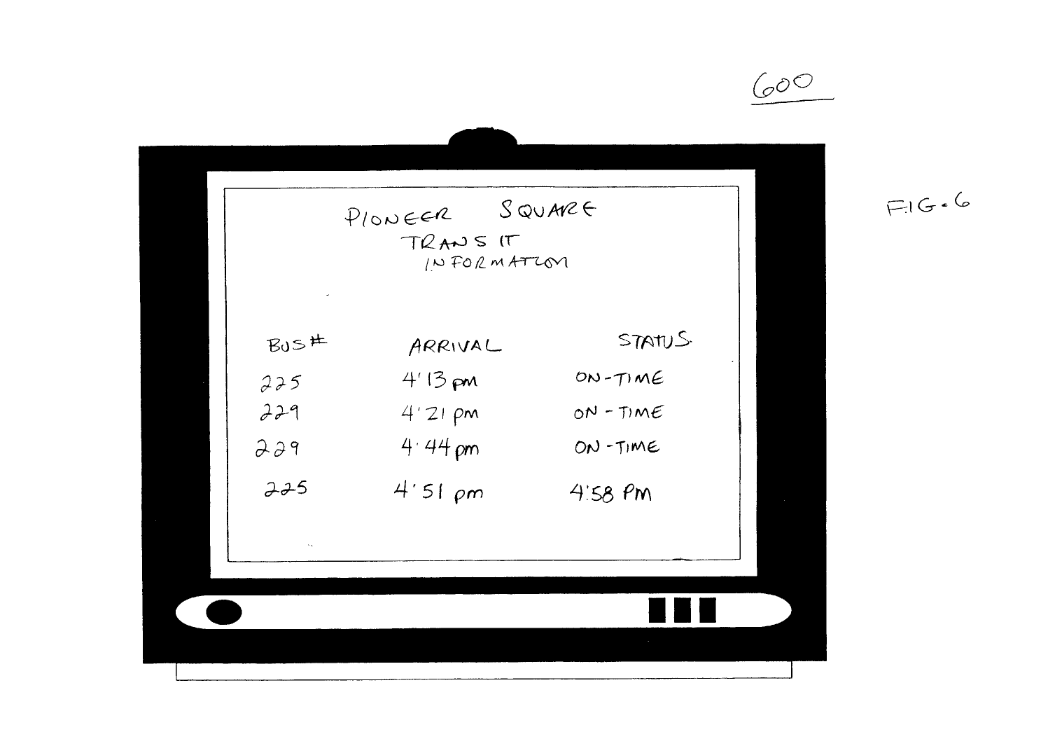

FIG. 6 shows a display unit 600 exemplar presenting bus information for the transit system 104. The presentation shows “PIONEER SQUARE TRANSIT INFORMATION.” The presentation also displays bus numbers (e.g., 225, 229), associated arrival times, and associated statuses (e.g., ON-TIME).

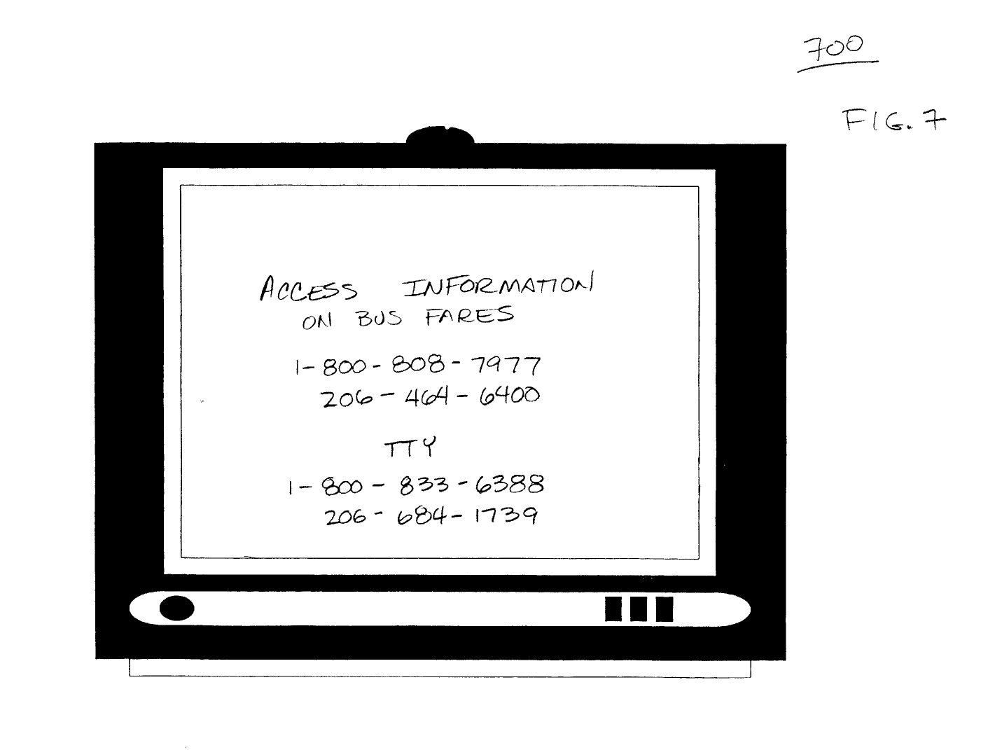

FIG. 7 shows a display unit 700 exemplar presenting public service information about the transit system 104. The presentation shows “ACCESS INFORMATION ON Bus FARES.” The presentation includes the phone numbers for hearing callers “1-800-808-7977” toll free and “206-464-6400” local. The presentation also includes the phone numbers for hearing impaired TTY callers “1-800-833-6388” toll free and “206-684-1739” local.

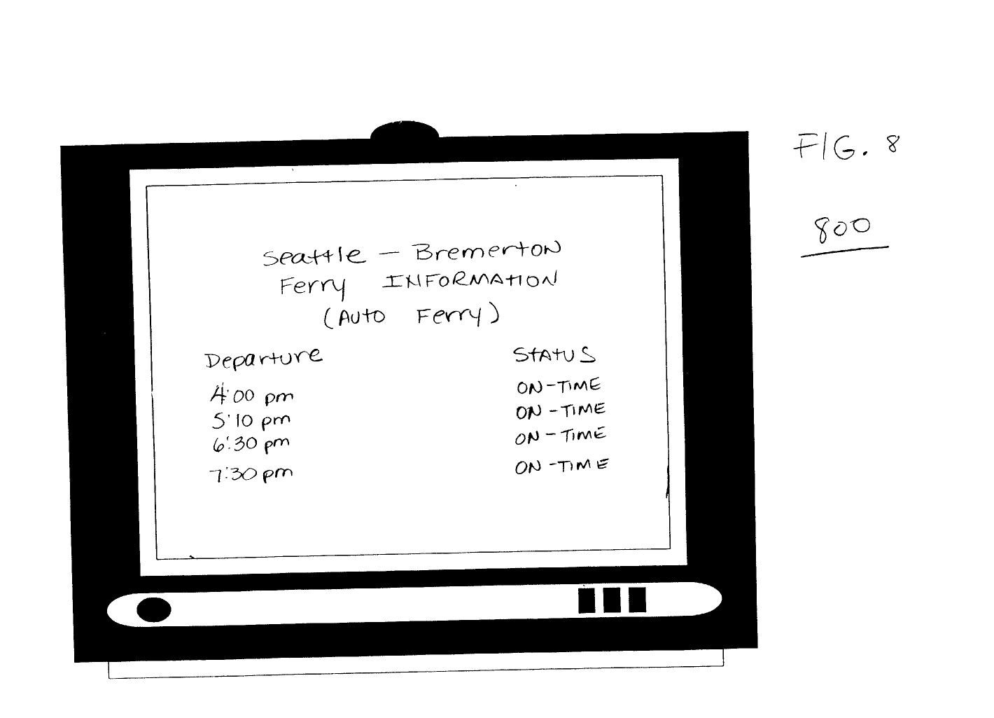

FIG. 8 shows a display unit 800 exemplar presenting ferry information for the ferry system 106 information. The presentation shows “SEATTLE-BREMERTON FERRY INFORMATION (AUTO FERRY)” information. The presentation includes the evening departure times and status for automobile ferries running between Seattle, Wash. and Bremerton, Wash.

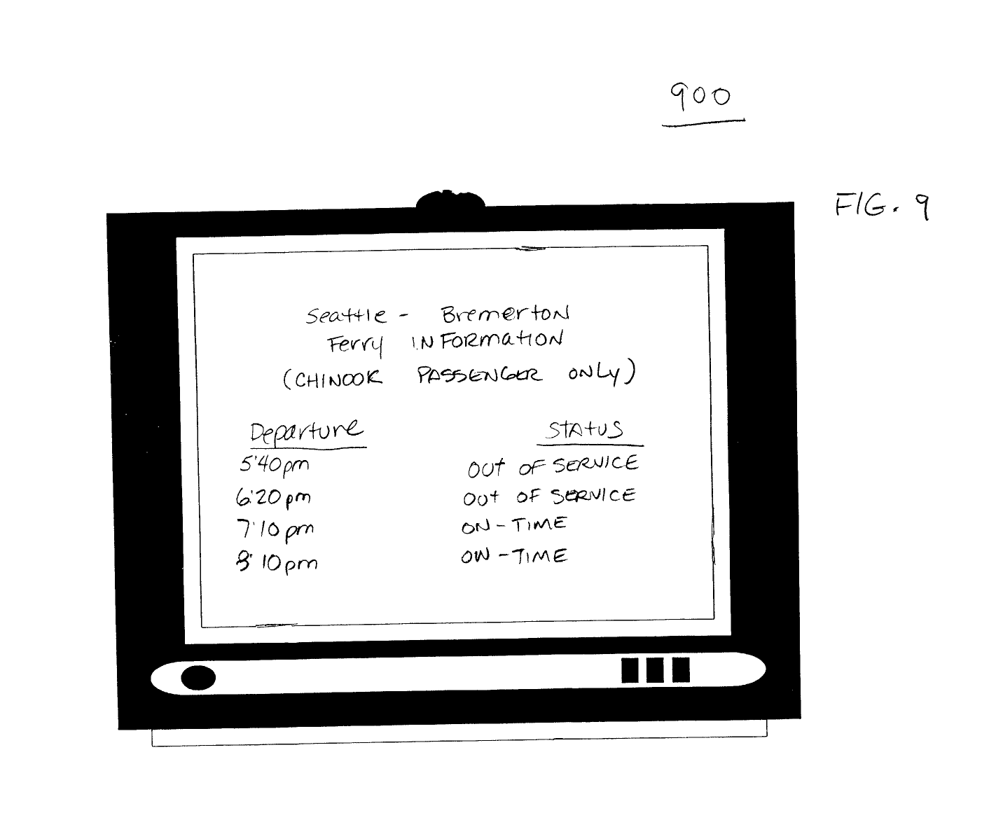

FIG. 9 shows an alternative display unit 900 presenting ferry information for the ferry system 106. The presentation shows “SEATTLE-BREMERTON FERRY INFORMATION (CHINOOK PASSENGER ONLY)” information. The presentation includes the evening departure times and status for foot ferries running between Seattle, Washington and Bremerton, Washington. Note that the display unit 900 shows that the 5:40 and the 6:20 foot ferries are out of service. This “out of service” information is exceptional information and is thus also presented at other display units affected by the two ferry runs being out of service (e.g., at Columbia Center 416 display units, the park 408 display units, etc.).

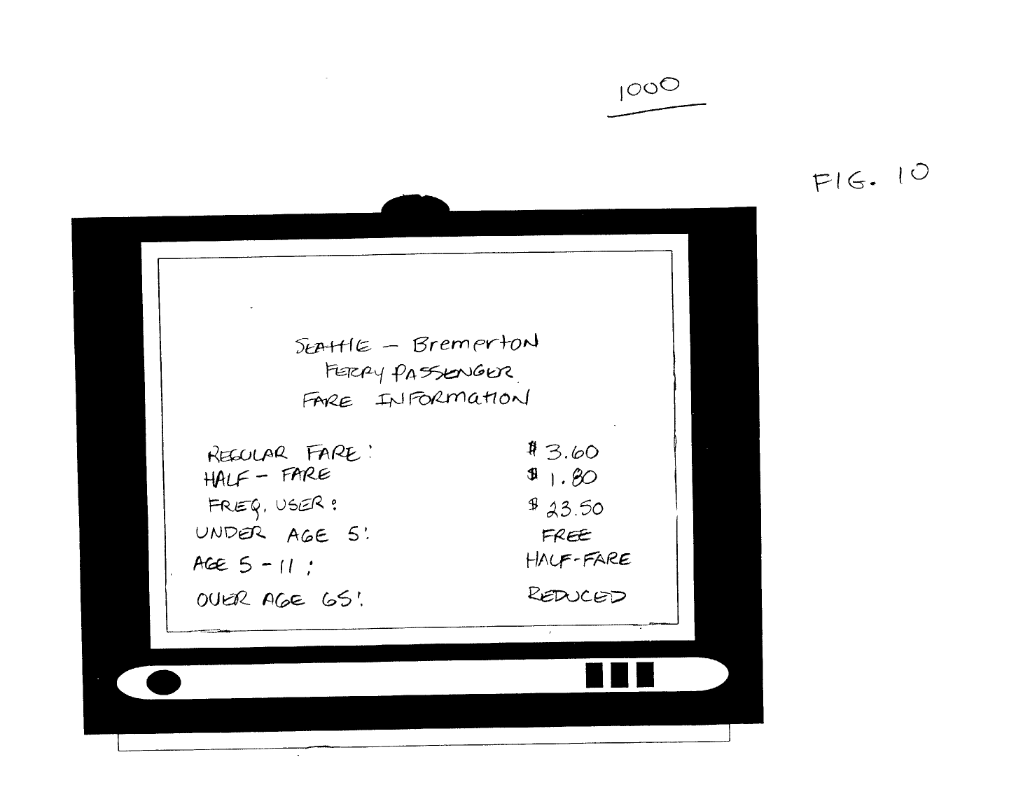

FIG. 10 shows a display unit 1000 exemplar presenting fare information for the ferry system 106. The presentation shows “SEATTLE-BREMERTON FERRY PASSENGER FARE INFORMATION” information. The presentation includes fares for passengers taking ferries running between Seattle, Wash. and Bremerton, Wash.

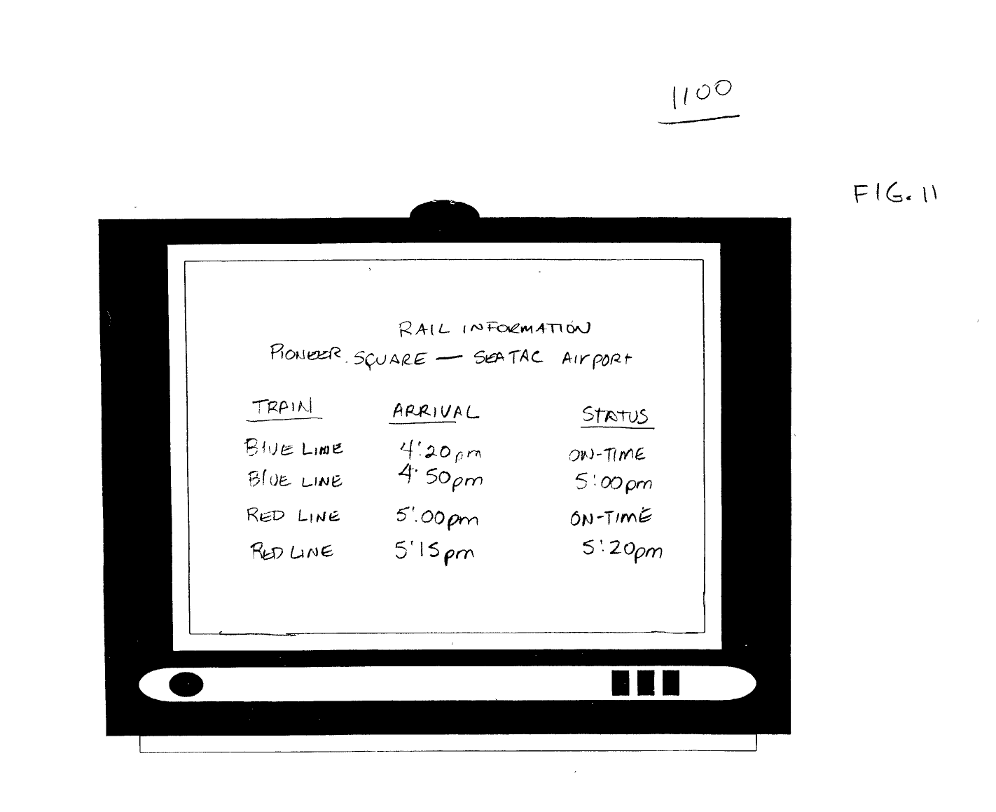

FIG. 11 shows a display unit 1100 exemplar presenting train information for the rail system 108 and the airline system 114. The presentation shows “PIONEER SQUARE-SEATAC AIRPORT” information. The presentation includes train designators (e.g., BLUE LINE, RED LINE), associated arrival times, and associated statuses.

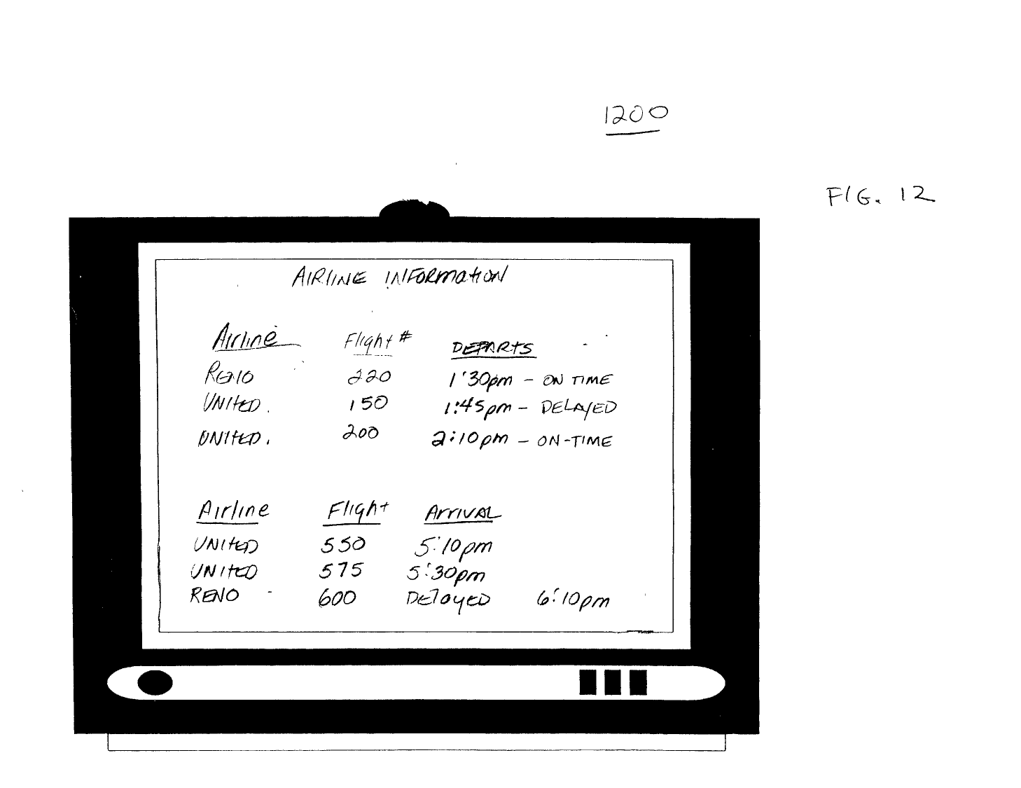

FIG. 12 shows a display unit 1200 exemplar presenting airplane information about the airline system 114. The presentation shows “AIRLINE INFORMATION,” as well as arrival and departure times. The presentation includes airline names (e.g., RENO, UNITED), associated flight numbers names (e.g., 220 150, 200, 550, 575, 600), and associated statuses (e.g., ON TIME, DELAYED). This information can be presented in any language, such as English, Spanish, Japanese, Swedish, Chinese, Swahili, Portuguese, Afrikaans, etc., to facilitate passengers arriving and departing from locations where the particular language is common.

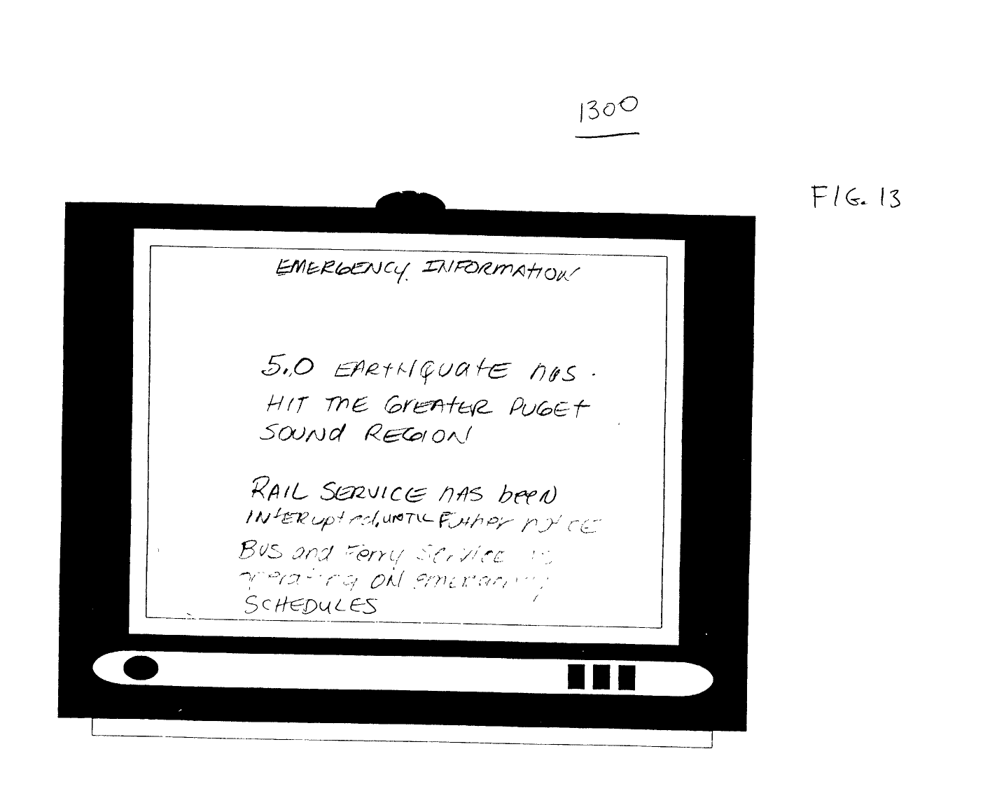

FIG. 13 shows a display unit 1300 exemplar presenting emergency information about the transit system 104, the ferry system 106, and the rail system 110 The presentation shows “EMERGENCY INFORMATION,” announces that a “5.0 EARTHQUAKE HAS HIT THE GREATER PUGET SOUND REGION,” and that “RAIL SERVICE HAS BEEN INTERRUPTED.” The presentation also informs readers that “UNTIL FURTHER NOTICE BUS AND FERRY SERVICE IS OPERATING ON EMERGENCY SCHEDULES.”

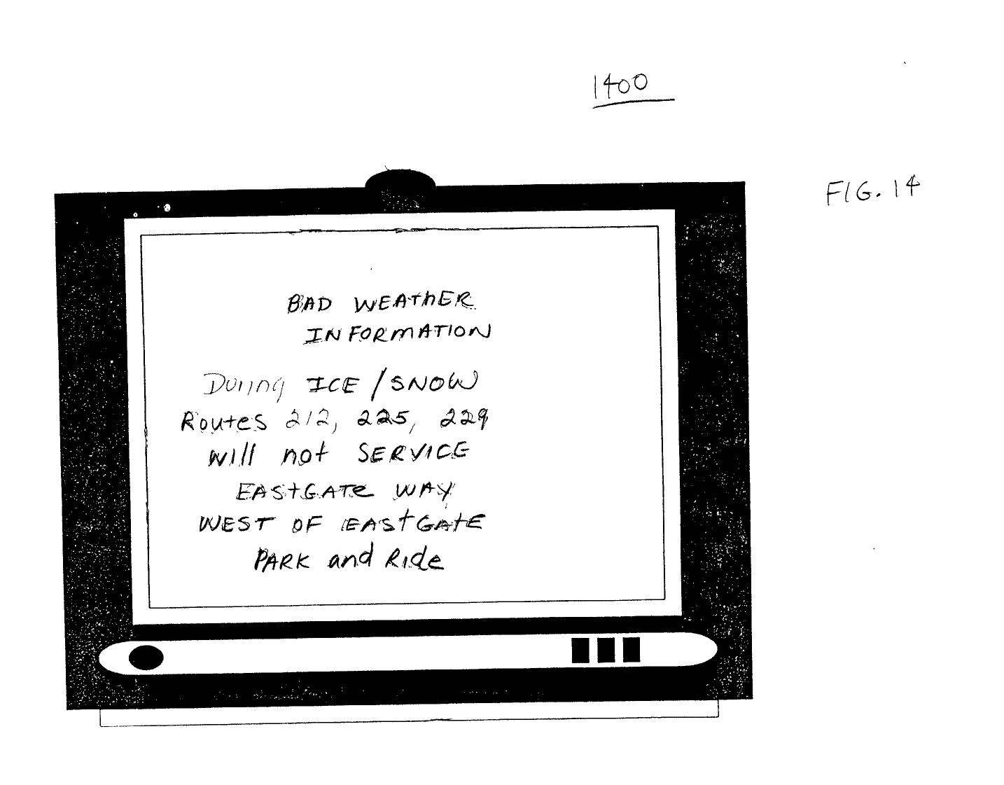

FIG. 14 shows a display unit 1400 exemplar presenting public service information about the weather and the transit system 104. The presentation shows “BAD WEATHER INFORMATION,” announces that a “DURING ICE/SNOW ROUTES 212, 225, 229 WILL NOT SERVICE EASTGATE WAY WEST OF EASTGATE PARK AND RIDE.”

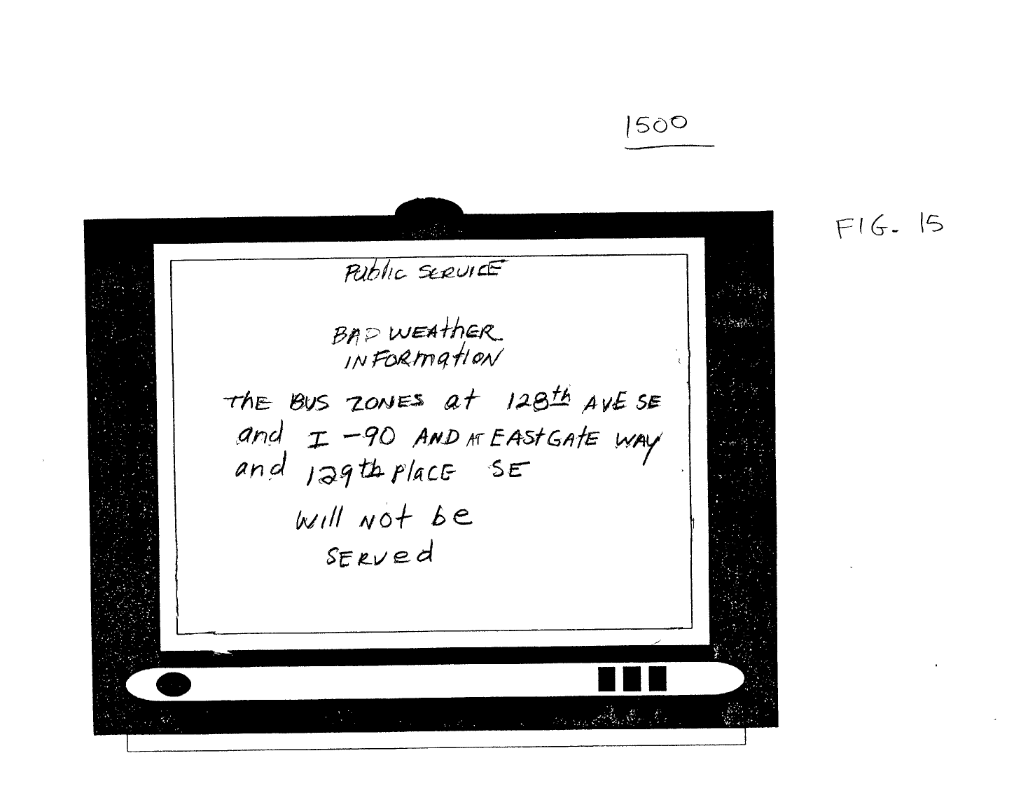

FIG. 15 shows an alternative display unit 1500 exemplar presenting public service information about the weather and the transit system 104. The presentation again reports “BAD WEATHER INFORMATION,” but alternatively informs readers that “THE BUS ZONES AT 128^{TH} AVE SE AND I-90 AND AT EASTGATE WAY AND 129^{TH} PLACE SE WILL NOT BE SERVED.”

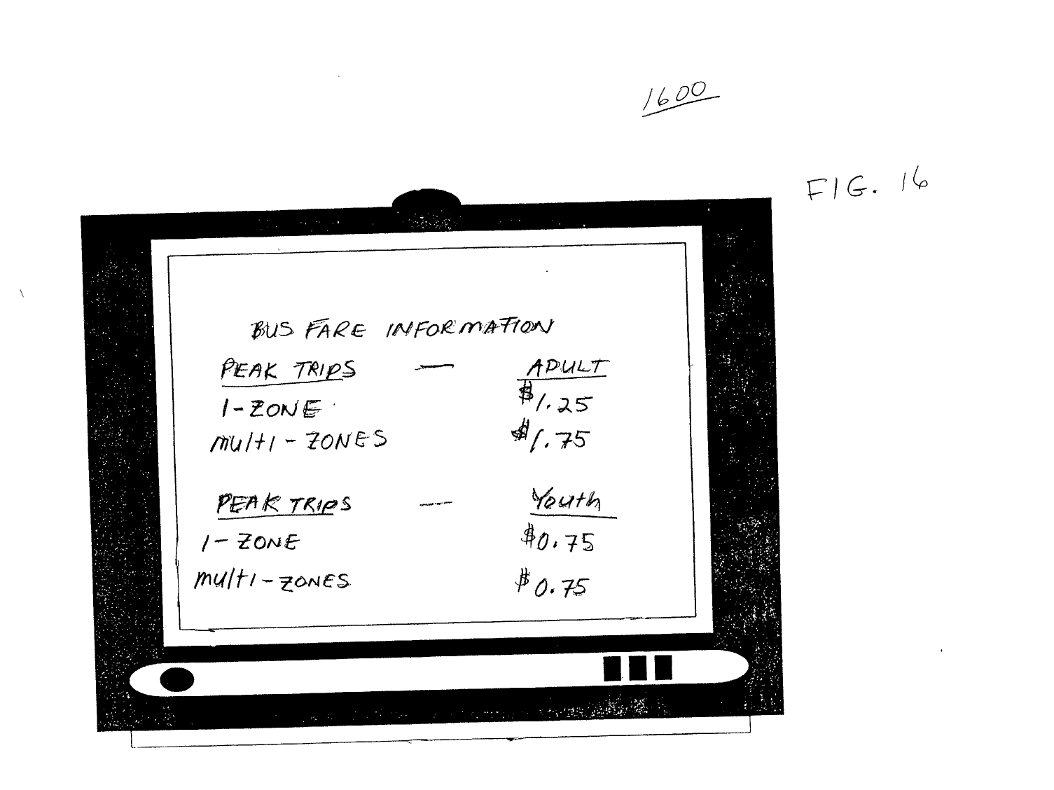

FIG. 16 shows a display unit 1600 exemplar presenting fare information for the transit system 104. The presentation shows “BUS FARE INFORMATION” and includes single zone and multiple zone adult and youth fares for passengers during peak hours of operation.

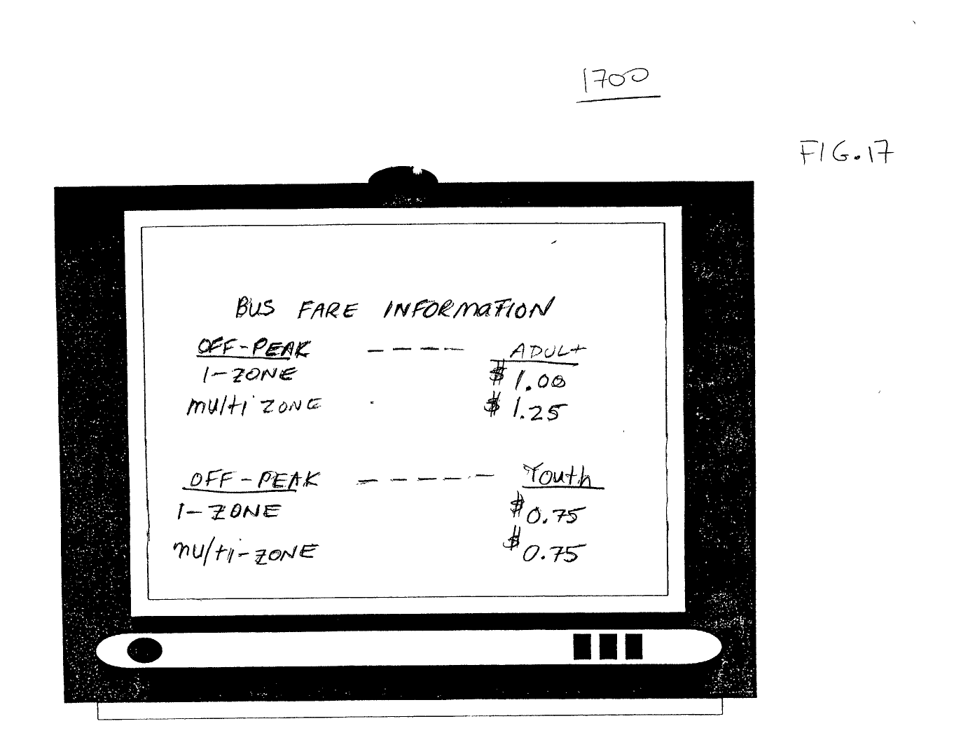

FIG. 17 shows an alternative display unit 1700 exemplar presenting fare information for the transit system 104. The presentation shows “Bus FARE INFORMATION” and includes single zone and multiple zone adult and youth fares for passengers during off-peak hours of operation.

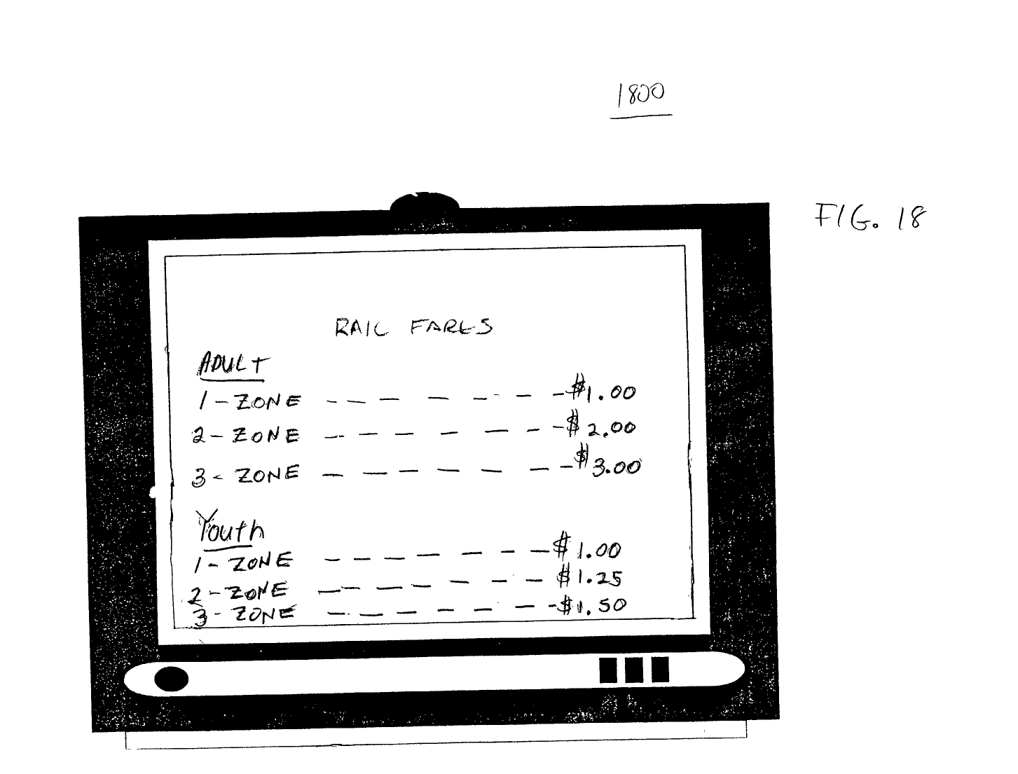

FIG. 18 shows a display unit 1800 exemplar presenting fare information for the rail system 108. The presentation shows “RAIL FARES” and includes single, double, and triple zone adult and youth fares.

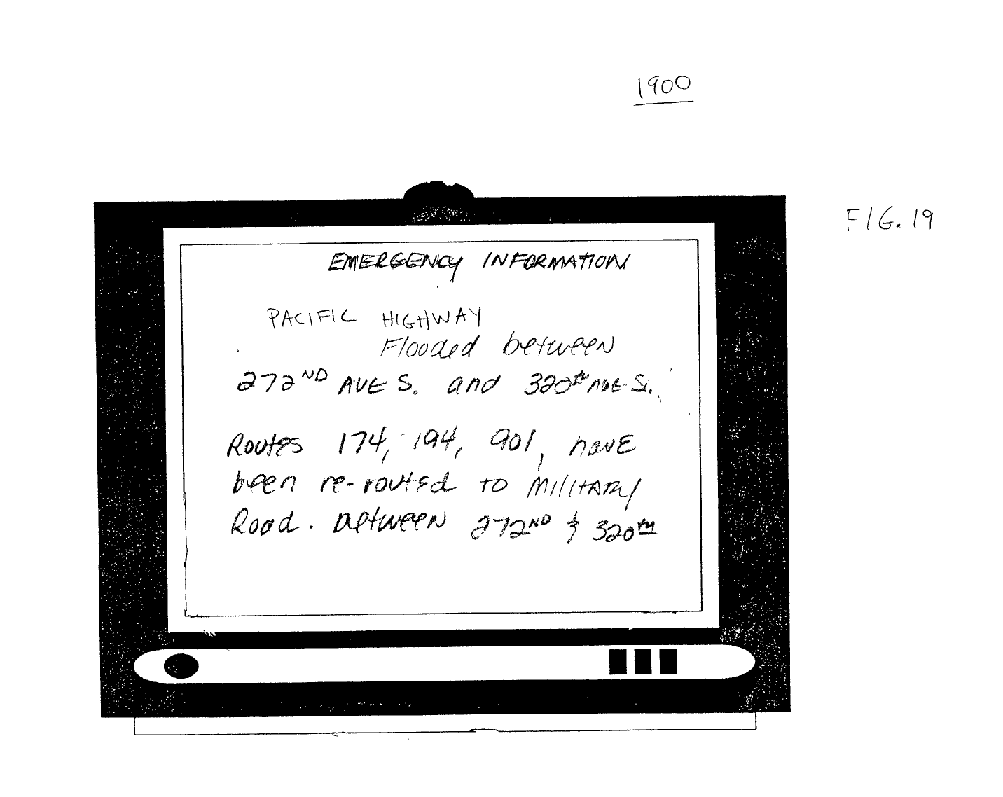

FIG. 19 shows a display unit 1900 exemplar presenting emergency information about the transit system 104. The presentation shows “EMERGENCY INFORMATION” and reports the road condition “PACIFIC HIGHWAY FLOODED BETWEEN 272^{ND} AVE S. AND 320^{TH} AVE S.” The presentation also informs readers that “ROUTES 174, 194, 901 HAVE BEEN RE-ROUTED TO MILITARY ROAD BETWEEN 272^{ND} AND 320^{TH}.”

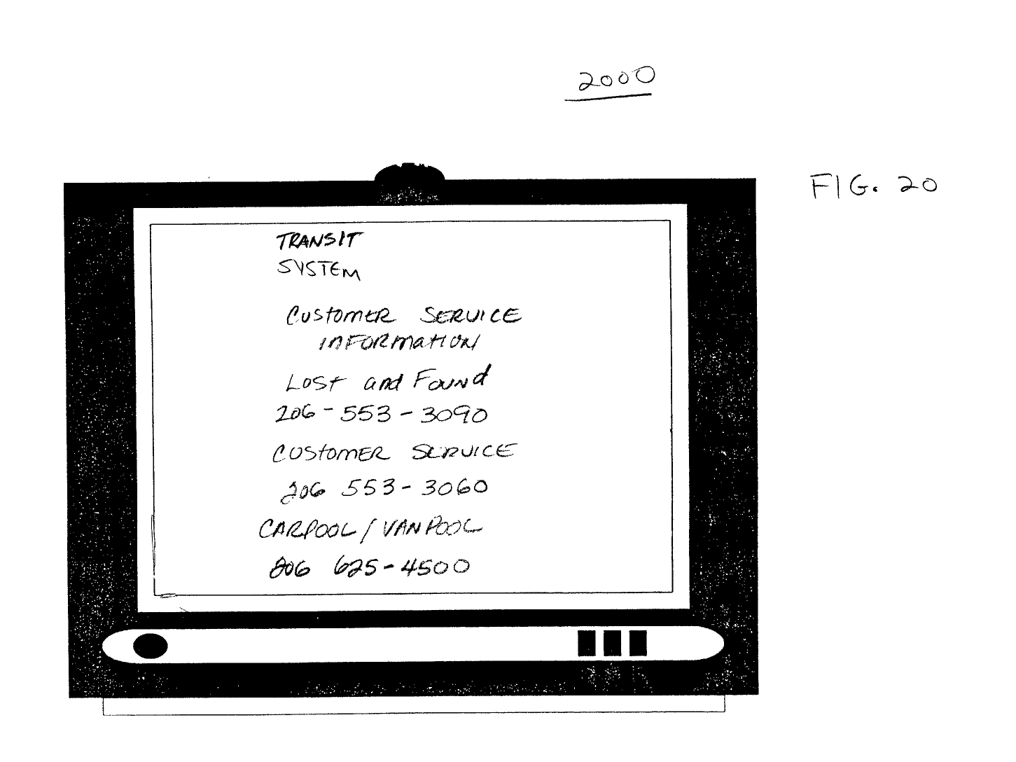

FIG. 20 shows a display unit 2000 presenting customer service information about the transit system 104. The presentation shows “TRANSIT SYSTEM CUSTOMER SERVICE INFORMATION.” The presentation includes a phone number for “LOST AND FOUND,” for “CUSTOMER SERVICE,” and for “CARPOOL/VANPOOL.”

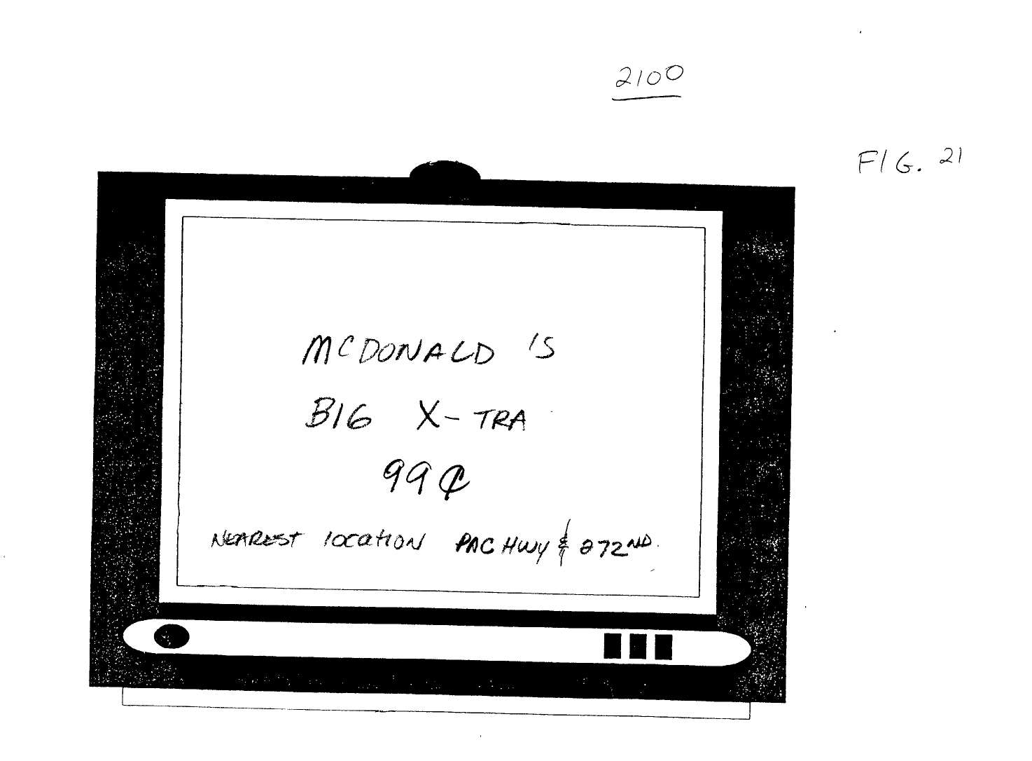

FIG. 21 shows a display unit 2100 presenting an advertisement from the advertising system 112. The presentation shows an advertisement for “McDONALD's BIG X-TRA 99¢” and that the nearest location is at Pacific Highway South and 272^{nd}. The advertisement is typically presented on an advanced television, such as HDTV, complete with audio, video, graphics, animation, color, etc. The display unit 2100 presents advertisements from vendors based on preprogrammed advertising slots. General non-public advertisements are presented on reader boards, monitors, or other advanced televisions. Advertisements from public entities, such as public service announcements, meeting announcements, etc., are presented on pages as captured from the data streams of information broadcast by the public entity.

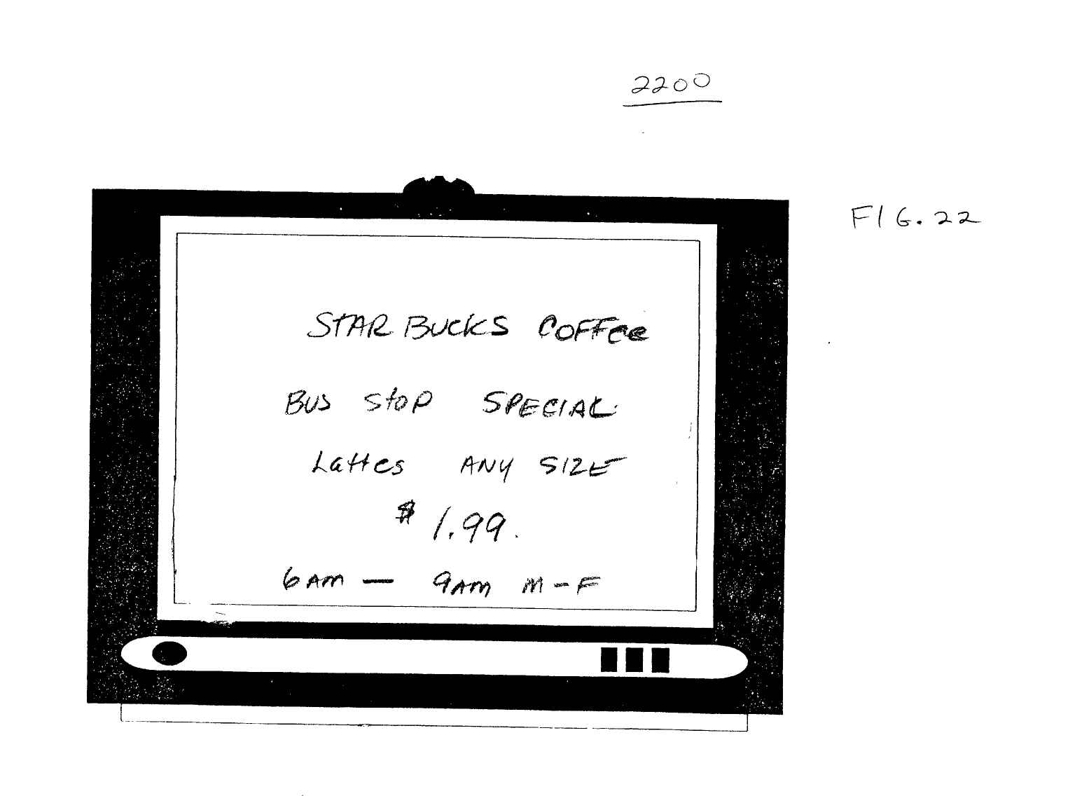

FIG. 22 shows a display unit 2200 presenting an advertisement from the advertising system 112 and to a display unit located at a bus stop. The presentation shows an advertisement for a “Bus STOP SPECIAL” at “STARBUCKS COFFEE” for “LATTES.” and that the nearest location is at Pacific Highway South and 272^{nd} The advertisement may be presented similar to the display depicted in FIG. 21.

III. Operation of Other Example Embodiments

Another example embodiment involves aiding airline passengers arriving for transport to Harborview Medical Center 416 via the Seattle Fire Department 402 during a medical emergency.

Another example embodiment monitors natural disasters and catastrophes. For example, if Mt. St. Helen's erupts the multimodal control center 102 extracts and assimilates exceptional data, and notifies trains, emergency systems, buses, ferries, airliners etc., that certain train tracks are impassable, visibility is minimal, “multiple wounded at hospital #1, please proceed to hospital #2,” etc. Similarly, if there is an earthquake, the multimodal control center 102 extracts and assimilates exceptional data, and notifies trains, emergency systems, buses, ferries, airliners etc., that certain train tracks are impassable, visibility is minimal, “multiple wounded at hospital #1, please proceed to hospital #2,” etc.

The multimodal control center 102 may be implemented using hardware, software, or a combination of hardware and software, and may be implemented in a computer system or other processing system. In an embodiment where the invention is implemented using a combination of hardware and software, the invention may be implemented using an application-specific integrated circuit (ASIC). In an embodiment where the invention is implemented using hardware, the hardware components may be a state machine. In an embodiment implemented using software, the software may be stored on a computer program product (such as an optical disk, a magnetic disk, a floppy disk, etc.) or a program storage device (such as an optical disk drive, a magnetic disk drive, a floppy disk drive, etc.).

IV. Conclusion

Although specific embodiments of and examples for the invention are described herein for illustrative purposes, various equivalent modifications are possible within the scope of the invention, as will be recognized by those skilled in the relevant art. The teachings provided herein of the invention can be applied to other intelligent transportation systems, not necessarily the examples of intelligent transportation systems described above. For example, the teachings provided herein can be applied to amusement parks that have self-contained, but dissimilar modes of transportation. Moreover, the presentation of transportation information is not limited to “exceptional data.” These and other changes may be made to the invention in light of the above-detailed description.

In the following claims the terms used should not be construed to limit the invention to the specific embodiment disclosed in the specification and claims, but should be construed to include all intelligent transportation systems that operate under the claims. The claims terms also should be construed to include all intelligent transportation systems that provide information from multiple modes of transportation to passengers in an entertaining, informative, and passenger-friendly way.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A transportation information system, comprising:
a processor configured to capture data from a first transportation mode and to provide the processed data at a second transportation mode.

2. The transportation information system of claim 1, further comprising a computer readable storage medium for use in the processor, wherein the computer readable storage medium includes instructions which when executed by the processor cause a display unit to present the processed data.

3. The transportation information system of claim 2, wherein the data presented includes tracking information, schedules, road conditions, weather, emergency information, public service information, routing information, status, location information, arrival and departure times, advertisements, messages, fares, connection times, or traffic conditions.

4. The transportation information system of claim 1 wherein the display unit is configured to present multimedia signals.

5. An apparatus for processing data for presentation on at least one remote display unit, comprising:
a processor configured to process data received from at least one data provider; and
a controller configured to receive the processed data and to present the processed data on display units.

6. The apparatus of claim 5, further comprising a computer readable storage medium for use in the processor wherein the computer readable storage medium includes instructions which when executed by the processor cause the apparatus to perform the steps of:
receiving the data from a data provider;
processing the data; and
transmitting the data to the display units.

7. The apparatus of claim 5 wherein the remote locations include at least one vehicle, at least one passenger stop, or in at least one building.

8. The apparatus of claim 5, further comprising a computer data signal embodied in a carrier wave comprising the data.

9. A transportation information system, comprising:
first and second transportation modes having first and second display devices, respectively;
a control center configured to capture data from the first and second transportation modes, to processes the captured data, and to display the processed data on the first and second display devices;
a computer readable storage medium, for use in the control center, having instructions which when executed by the control center cause the transportation information system to capture the data, process the captured data, and to present the processed data on the display devices; and
a computer data signal embodied in a carrier wave comprising the processed data, wherein the computer data signal is transmitted from the control center to the first and second display devices.

10. The apparatus of claim 9 wherein the display device is a multimedia display device and presents the processed data using multimedia.

11. The apparatus of claim 9 wherein the data includes tracking information, transportation schedules, road conditions, weather, emergency information, public service information, routing information, status, location information, arrival and departure times, advertisements, messages, fares, connection times, or traffic conditions.

12. In a transportation network, a method of providing information comprising the steps of:
transmitting using a data stream data from a first transportation unit;
monitoring the data stream for exceptional data;
capturing exceptional data from the data stream;
assimilating the captured data with other data stored in at least one database;
analyzing the assimilated data to identify at least one display unit associated with a second transportation unit;
transmitting the captured data to the display unit;
presenting the captured data at the display unit.
